(19) United States
(12) Patent Application Publication
(10) Pub. No.: US 2020/0180365 A1
(43) Pub. Date: Jun. 11, 2020

(54) PNEUMATIC TIRE

(71) Applicant: TOYO TIRE CORPORATION, Itami-shi (JP)

(72) Inventor: Seiji Yokomakura, Itami-shi (JP)

(21) Appl. No.: 16/704,553

(22) Filed: Dec. 5, 2019

(30) Foreign Application Priority Data
Dec. 10, 2018 (JP) 2018-230923
Nov. 13, 2019 (JP) 2019-205624

(51) Int. Cl. B60C 15/06; B60C 13/00

(52) U.S. Cl. CPC B60C 15/0607; B60C 2015/0614; B60C 2015/061; B60C 13/001

(57) ABSTRACT

A pneumatic tire includes a bead core, a bead filler located outside in a tire radial direction of the bead core, a carcass ply laid over between bead cores and bead fillers which are provided in a pair in the tire width direction respectively, a belt wound on an outside in the tire radial direction of the carcass ply, a tread portion located outside in the tire radial direction of the belt, and a sidewall portion located outside in the tire width direction of the carcass ply. A thickness dimension of the tire side portion is set to increase as proceeding from a tire maximum width position toward an outside in the tire radial direction.

### CROSS-REFERENCE TO RELATED APPLICATIONS

This application claims priority of Japanese Patent Application No.: 2018-230923 filed on Dec. 10 2018 and No.: 2019-205624 filed on Nov. 13, 2019, the content of which are incorporated herein by reference.

### BACKGROUND OF THE INVENTION

### Technical Field

The present invention relates to a pneumatic tire.

### Description of the Related Art

Conventionally, a pneumatic tire is known, the pneumatic tire including a carcass extending from a tread portion to a bead core of a bead portion via a sidewall portion, and a belt layer formed of a plurality of belt plies including a belt ply having a maximum width and disposed on the radially outside of the carcass and inside the tread portion (see, for example, JP4950616).

However, the above-described conventional pneumatic tire is intended to suppress rolling resistance, and all of enhancing external damage resistance and rigidity at a tire side portion and improving a ground contact performance and ride comfort are not fully considered.

### CITATION LIST

### Patent Literature

[symbol]

### SUMMARY

An object of the present invention is to provide a pneumatic tire capable of improving a ground contact performance and ride comfort while enhancing external damage resistance and rigidity at a tire side portion.

The present invention provides, in order to solve the above-described problems, a pneumatic tire including a bead core, a bead filler that is located outside in a tire radial direction of the bead core, a carcass ply that is laid over between bead cores and bead fillers which are provided in a pair in the tire width direction respectively, a belt that is wound on an outside in the tire radial direction of the carcass ply, a tread portion that is located outside in the tire radial direction of the belt, and a sidewall portion that is located outside in the tire width direction of the carcass ply, in which a thickness dimension of a tire side portion is set to increase as proceeding from a tire maximum width position toward an outside in the tire radial direction.

According to the present invention, since the thickness dimension of the tire side portion on the outside in the tire radial direction with respect to the tire maximum width position is set to be greater, the external damage resistance especially on the outside in the tire radial direction in the tire side portion can be enhanced. Moreover, since the rigidity of the tire side portion on the outside in the tire radial direction with respect to the tire maximum width position increases due to the thickness dimension set to be greater, it is easy to suppress deformation of the tire side portion on the outside in the tire radial direction with respect to the tire maximum width position. As a result, since deformation of the tread portion continuous to an outer end portion in the tire radial direction of the tire side portion is suppressed, the ground contact performance of the tread portion is improved. Furthermore, by adopting an configuration in which the thickness dimension at the tire maximum width position, which is easy to bend in the tire side portion, is relatively small, it is easy to actively bend the tire side portion at the tire maximum width position, which achieves an vibration absorption property to be improved. Therefore, ride comfort is improved.

It is preferable that an upper end position of the bead filler is located inside in the tire radial direction with respect to the tire maximum width position, and assuming that the thickness dimension of the tire side portion is tx, and the thickness dimension of the tire side portion at the tire maximum width position is a reference thickness ts, in a range from the upper end position of the bead filler to the tire maximum width position, the thickness dimension tx satisfies ts≤tx≤1.1×ts.

With this configuration, the thickness dimension tx of the tire side portion is equal to or greater than the reference thickness ts at the tire maximum width position in the range between the bead filler and the tire maximum width position. Furthermore, the bead filler is generally harder and more rigid than the sidewall portion. Therefore, it is easier to bend the tire side portion more actively at the tire maximum width position where the thickness dimension tx is the smallest on the outside in the tire radial direction with respect to the bead filler having higher rigidity. Therefore, the tire side portion can be flexed effectively, and ride comfort is further improved.

It is preferable that the pneumatic tire further includes a chafer that covers the bead core and a part of the bead filler, and a chafer pad that is located outside in the tire width direction of the chafer and the bead filler, an upper end position of the chafer pad is located outside in the tire radial direction with respect to the tire maximum width position, and assuming that the thickness dimension of the tire side portion at the tire maximum width position is a reference thickness ts, in a range from the tire maximum width position to the upper end position of the chafer pad, the thickness dimension tx satisfies ts<tx≤1.1×ts.

With this configuration, since an excessive increase in the thickness of the tire side portion is suppressed and an excessive increase in rigidity of the tire side portion is suppressed, the tire side portion can be effectively flexed and an effect of improving ride comfort is obtained.

It is preferable that assuming that a tire height is H, and assuming that the thickness dimension of the tire side portion at the tire maximum width position is a reference thickness ts, in a range from the tire maximum width position to a position separated by 0.05×H outside in the tire radial direction, the thickness dimension tx satisfies ts<tx≤1.15×ts.

With this configuration, since an excessive increase in the thickness of the tire side portion is suppressed and an excessive increase in rigidity of the tire side portion is suppressed, the tire side portion can be effectively flexed and an effect of improving ride comfort is obtained.

It is preferable that a range in which the thickness dimension of the tire side portion increases is up to a region where an end of a maximum width belt is located in the tire radial direction.

It is preferable that the sidewall portion includes a design portion on a surface, and a thickness dimension td of the design portion gradually decreases as proceeding from the tire maximum width position toward the maximum width belt end.

With this configuration, it is possible to prevent the rigidity of the tire side portion from becoming too high due to the design portion.

It is preferable that assuming that the tire height is H, and assuming that the thickness dimension of the tire side portion at the tire maximum width position is a reference thickness ts, in a range from a position separated by 0.05×H to a position separated by 0.17×H outside in the tire radial direction with respect to the tire maximum width position, the thickness dimension tx satisfies 1.10×ts≤tx≤1.20×ts.

It is preferable that the tread portion has edges at both ends in the tire width direction.

According to the present invention, since the thickness dimension of the tire side portion is set to increase as proceeding from the tire maximum width position toward the outside in the tire radial direction, the external damage resistance and the rigidity of the tire side portion can be enhanced. In addition, the ground contact performance of the tread portion improves by enhancing the rigidity of the tire side portion. Furthermore, ride comfort is improved by actively bending the tire side portion at the tire maximum width position.

### BRIEF DESCRIPTION OF THE DRAWINGS

The foregoing and the other features of the present invention will become apparent from the following description and drawings of an illustrative embodiment of the invention in which:

FIG. 1 is a meridian half cross-sectional view of a pneumatic tire according to an embodiment of the present invention; and

FIG. 2 is an enlarged view illustrating the periphery of a maximum width position of a tire side portion in FIG. 1.

### DETAILED DESCRIPTION OF EMBODIMENTS

An embodiment according to the present invention will be described below with reference to the accompanying drawings. Note that the following description is essentially an example only and does not intend to limit the present invention, an application thereof, or the use thereof. In addition, the drawings are schematic, and the ratio of each dimension and the like may not match the actual one.

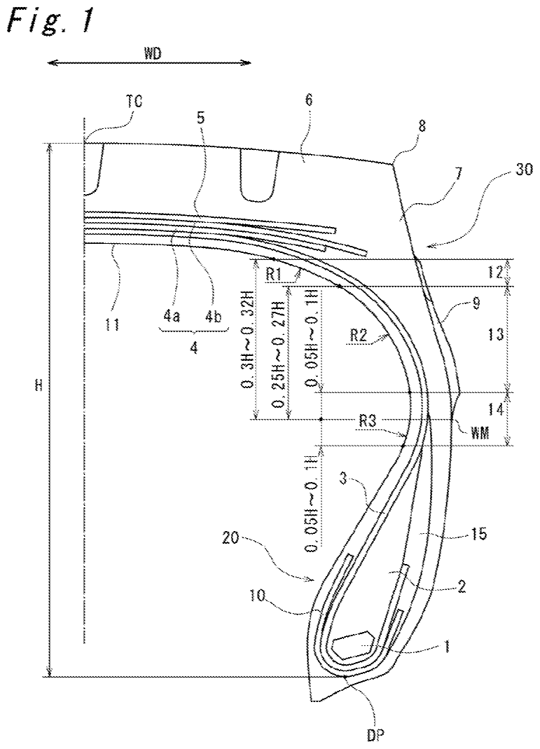

FIG. 1 is a meridian half cross-sectional view of a pneumatic tire according to an embodiment. In this pneumatic tire, a bead core 1 is disposed on each of both sides in a tire width direction WD.

Although not illustrated in detail, the bead core 1 has a configuration in which a single bead wire (steel wire) is wound a plurality of times into a ring shape and is bundled together. The bead core 1 is disposed on each of both sides in the tire width direction, and fixes the pneumatic tire to a rim flange portion of a wheel, not illustrated. The bead core 1 supports cord tension of a carcass ply 3 generated by the internal pressure of the pneumatic tire.

A bead filler 2 is disposed outside in a tire radial direction of each of the bead cores 1.

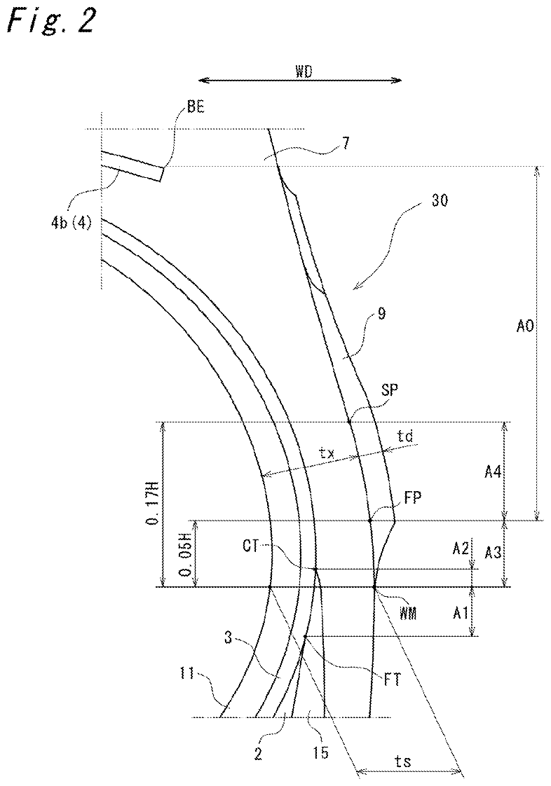

The bead filler 2 is made of a rubber material formed into an annular shape having a substantially triangular cross section. That is, a thickness dimension of the bead filler 2 gradually decreases as proceeding from the bead core 1 toward the outside in the tire radial direction. A distal end position FT (see FIG. 2) of the bead filler 2 is located inside in the tire radial direction with respect to a tire maximum width position WM. Here, the tire maximum width position WM is a position on the outermost side in the tire width direction in a tire side portion, excluding a design portion 9 to be described later.

The carcass ply 3 is laid over between bead cores 1 and bead fillers 2 which are provided in a pair in the tire width direction respectively. A belt 4 and a reinforcing belt 5 are wound on the outside in the tire radial direction of the carcass ply 3. The belt 4 is configured of two sheets, that is, a first belt 4a on the inside in the tire radial direction and a second belt 4b on the outside in the tire radial direction. The second belt 4b has a greater dimension in the tire width direction than that of the first belt 4a, and covers the first belt 4a. Both ends (maximum width belt ends) of the second belt 4b in the tire width direction extend toward sidewall portions 7 to be described later.

A tread portion 6 is formed of tread rubber on the outside in the tire radial direction of the reinforcing belt 5. The sidewall portions 7 are formed of sidewall rubber on both sides in the tire width direction WD from the tread portion 6.

An edge 8 is formed at a boundary position between the tread portion 6 and the sidewall portion 7. An area between the edges 8 on the both sides in the tire width direction is a ground contact surface of the tread portion 6. In addition, a portion extending from the edge 8, the portion being covered with sidewall rubber becomes a tire side portion 30. Here, in the present specification, the tire side portion 30 means a region that extends between the edge 8 and a bead portion 20 in the tire radial direction, in the pneumatic tire. The bead portion 20 means a region where the bead core 1 and the bead filler 2 are provided in the tire radial direction, in the pneumatic tire.

The sidewall portion 7 has different thickness dimensions in the tire radial direction. That is, the sidewall portion 7 is formed such that the thickness dimension increases as proceeding from the tire maximum width position WM toward the outside in the tire radial direction.

On an outer surface of the sidewall portion 7, the design portion 9 is provided from the tire maximum width position WM toward the outside in the tire radial direction. The design portion 9 is obtained by integrating a rubber material different from the sidewall rubber into the sidewall portion 7. The design portion 9 is configured of marks such as characters and symbols representing the tire manufacturer name, the product name, the size, and the like. In the design portion 9, a thickness dimension td (see FIG. 2) gradually increases as proceeding from the tire maximum width position WM toward the outside in the tire radial direction, and thereafter the thickness dimension td gradually decreases.

Specifically, assuming that a tire height is H, the thickness dimension td of the design portion 9 increases in a range up to a distance of 0.05×H from the tire maximum width position WM toward the outside in the tire radial direction, and gradually decreases as proceeding toward the outside in the tire radial direction from this range. Here, the tire height H refers to the distance in the tire radial direction from a lower position DP of a chafer 10 wound around the bead core 1 to a center position TC on the outer surface of the tread portion 6, when the distance is measured in a state where the distance between a pair of the bead portions 20 is set to a standard rim width in a sample obtained by cutting a pneumatic tire in the tire radial direction within a predetermined range in a tire circumferential direction (for example, the range of 20 mm in the tire circumferential direction).

The chafer 10 is wound around the bead core 1 so as to cover the laid-over carcass ply 3. An inner liner 11 is provided inside in the tire radial direction of the carcass ply 3. Radii of curvature of an inner surface of the inner liner 11 differ in the region corresponding to the sidewall portion 7. A first region 12 having a radius of curvature R1, a second region 13 having a radius of curvature R2, and a third region 14 having a radius of curvature R3 are formed in that order from the tread portion 6 side toward the bead portion 20 side. The first region 12 is a portion that starts from the range of 0.3H to 0.32H on the outside in the tire radial direction from the tire maximum width position WM and ends at the range of 0.25H to 0.27H on the upper side from the tire maximum width position WM. The second region 13 is a portion that is continuous to the first region 12 and ends at the range of 0.05H to 0.1H on the outside in the tire radial direction from the tire maximum width position WM. The third region 14 is a portion that is continuous to the second region 13 and ends at the range of 0.05H to 0.1H on the inside in the tire radial direction from the tire maximum width position WM.

A chafer pad 15 is provided between the sidewall rubber and the bead filler 2 and the carcass ply 3 on the outside in the tire width direction of the bead filler 2 and the carcass ply 3. The thickness dimension of the distal end portion of the chafer pad 15 gradually decreases as proceeding toward the outside in the tire radial direction. A distal end position CT (see FIG. 2) of the chafer pad 15 is located outside in the tire radial direction with respect to the tire maximum width position WM.

FIG. 2 illustrates the periphery of the tire maximum width position WM in the tire side portion 30 of FIG. 1 in an enlarged manner. With reference to FIG. 2, a thickness dimension tx of the tire side portion 30 will be described in detail. The thickness dimension tx of the tire side portion 30 is a distance between the inner surface of the inner liner 11 and the outer surface of the sidewall portion 7 in a normal direction at each position on the inner surface of the inner liner 11 in a tire meridian cross-sectional view. The thickness dimension tx at each position in the tire side portion 30 is set as follows.

The thickness dimension tx of the tire side portion 30 is designed to gradually increase in an outer diameter-side range A0 from the tire maximum width position WM to a maximum width belt end BE as proceeding toward the outside in the tire radial direction.

If this condition is satisfied, the thickness dimension of the tire side portion 30 on the outside in the tire radial direction with respect to the tire maximum width position WM is set to be greater. Therefore, the external damage resistance especially on the outside in the tire radial direction in the tire side portion 30 can be enhanced. Moreover, since the rigidity of the tire side portion 30 on the outside in the tire radial direction with respect to the tire maximum width position WM increases due to the thickness dimension set to be greater, it is easy to suppress deformation of the tire side portion 30 on the outside in the tire radial direction. As a result, since deformation of the tread portion 6 continuous to the outer end portion in the tire radial direction of the tire side portion 30 is suppressed, the ground contact performance of the tread portion 6 is improved. Furthermore, by adopting an configuration in which the thickness dimension at the tire maximum width position WM which is easy to bend in the tire side portion 30 is relatively small, it is easy to actively bend the tire side portion 30 at the tire maximum width position WM, and an vibration absorption property is improved by bending the tire side portion 30 at the tire maximum width position WM. Therefore, ride comfort is improved.

Assuming that the thickness dimension of the tire side portion 30 at the tire maximum width position WM is a reference thickness ts, in a first range A1 from the tire maximum width position WM to the distal end position FT of the bead filler 2, the thickness dimension tx of the tire side portion 30 satisfies

ts≤tx≤1.1×ts.

As a result, the thickness dimension tx of the tire side portion 30 is equal to or greater than the reference thickness ts at the tire maximum width position WM in the range between the bead filler 2 and the tire maximum width position WM. Furthermore, the bead filler 2 is generally harder and more rigid than the sidewall portion 7. Therefore, the tire side portion 30 is easily bent more actively at the tire maximum width position WM where the thickness dimension tx is smallest on the outside in the tire radial direction with respect to the bead filler 2 having higher rigidity. Therefore, the tire side portion 30 can be flexed effectively, and ride comfort is further improved.

If this condition is satisfied, the tire side portion 30 can be flexed effectively and the effect of improving the ride comfort can be obtained.

In a second range A2 from the tire maximum width position WM to the distal end position CT of the chafer pad 15, the thickness dimension tx of the tire side portion 30 satisfies

ts<tx≤1.1×ts.

If this condition is satisfied, since an excessive increase in the thickness dimension tx of the tire side portion 30 is suppressed and an excessive increase in rigidity of the tire side portion 30 is suppressed, the tire side portion 30 can be effectively flexed and the effect of improving ride comfort is obtained.

In a third range A3 from the tire maximum width position WM to a first position FP separated by the distance of 0.05×H to the outside in the tire radial direction with respect to the tire maximum width position WM, the thickness dimension tx of the tire side portion 30 satisfies

ts<tx≤1.15×ts.

If this condition is satisfied, since an excessive increase in the thickness dimension tx of the tire side portion 30 is suppressed and an excessive increase in rigidity of the tire side portion 30 is suppressed, the tire side portion 30 can be effectively flexed and the effect of improving ride comfort is obtained.

In a fourth range A4 from the first position FP to a second position SP separated by the distance of 0.12×H to the outside in the tire radial direction with respect to the first position FP (distance of 0.17×H to the outside in the tire radial direction with respect to the tire maximum width position WM), the thickness dimension tx of the tire side portion 30 satisfies

1.10×ts≤tx≤1.20×ts.

If this condition is satisfied, since an excessive increase in the thickness dimension tx of the tire side portion 30 is suppressed and an excessive increase in rigidity of the tire side portion 30 is suppressed, the tire side portion 30 can be effectively flexed and the effect of improving ride comfort is obtained.

What is claimed is:

1. A pneumatic tire comprising:
a bead core;
a bead filler that is located outside in a tire radial direction of the bead core;
a carcass ply that is laid over between bead cores and bead fillers which are provided in a pair in the tire width direction respectively;
a belt that is wound on an outside in the tire radial direction of the carcass ply;
a tread portion that is located outside in the tire radial direction of the belt; and
a sidewall portion that is located outside in the tire width direction of the carcass ply,
wherein a thickness dimension of a tire side portion is set to increase as proceeding from a tire maximum width position toward an outside in the tire radial direction.

2. The pneumatic tire according to claim 1,
wherein an upper end position of the bead filler is located inside in the tire radial direction with respect to the tire maximum width position, and
assuming that a thickness dimension of the tire side portion is tx and a thickness dimension of the tire side portion at the tire maximum width position is a reference thickness ts, in a range from the upper end position of the bead filler to the tire maximum width position, the thickness dimension tx of the tire side portion satisfies
ts≤tx≤1.1×ts.

3. The pneumatic tire according to claim 1 further comprising:
a chafer that covers the bead core and a part of the bead filler; and
a chafer pad that is located outside in the tire width direction of the chafer and the bead filler,
wherein an upper end position of the chafer pad is located outside in the tire radial direction with respect to the tire maximum width position, and
assuming that the thickness dimension of the tire side portion at the tire maximum width position is a reference thickness ts, in a range from the tire maximum width position to the upper end position of the chafer pad, the thickness dimension tx of the tire side portion satisfies
ts<tx≤1.1×ts.

4. The pneumatic tire according to claim 1,
wherein assuming that a tire height is H, and
assuming that the thickness dimension of the tire side portion at the tire maximum width position is a reference thickness ts, in a range from the tire maximum width position to a position separated by 0.05×H outside in the tire radial direction, the thickness dimension tx of the tire side portion satisfies
ts<tx≤1.15×ts.

5. The pneumatic tire according to claim 1,
wherein a range in which the thickness dimension of the tire side portion increases is up to a region where a maximum width belt end is located in the tire radial direction.

6. The pneumatic tire according to claim 1,
wherein the sidewall portion includes a design portion on a surface, and
a thickness dimension td of the design portion gradually decreases as proceeding from the tire maximum width position toward the maximum width belt end.

7. The pneumatic tire according to claim 1,
wherein assuming that the tire height is H, and assuming that the thickness dimension of the tire side portion at the tire maximum width position is a reference thickness ts,
in a range from a position separated by from 0.05×H to a position separated by 0.17×H outside in the tire radial direction with respect to the tire maximum width position, the thickness dimension tx of the tire side portion satisfies
1.10×ts≤tx≤1.20×ts.

8. The pneumatic tire according to claim 1, wherein the tread portion has edges at both ends in the tire width direction.
